(19) United States
(12) Patent Application Publication
(10) Pub. No.: US 2010/0306491 A1
(43) Pub. Date: Dec. 2, 2010

(54) Data storage device

(75) Inventors: Sun-mi Yoo, Seoul (KR); Min-cheol Kwon, Seoul (KR); Seong-jun Ahn, Seoul (KR); Shine Kim, Suwon-si (KR); Mi-kyeong Kang, Hwaseong-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/661,352

(22) Filed: Mar. 16, 2010

(30) Foreign Application Priority Data
Jun. 2, 2009 (KR) 10-2009-0048650

(51) Int. Cl. G06F 12/02; G06F 12/10

(52) U.S. Cl. 711/165; 711/202; 711/E12.002; 711/E12.058

(57) ABSTRACT

A data storage device capable of improving reading and writing performance includes at least one memory chip comprising a control unit and a plurality of blocks for storing data, and communicating with a host through a channel; and memory storing data output from the at least one memory chip. The control unit may sequentially read data having continuous logic addresses and discontinuous physical addresses from the plurality of blocks and store the data in the memory to have continuous physical addresses.

### CROSS-REFERENCE TO RELATED APPLICATIONS

This application claims the benefit of Korean Patent Application No. 10-2009-0048650, filed on Jun. 2, 2009, in the Korean Intellectual Property Office, the entire contents of which are incorporated herein by reference.

### BACKGROUND

The inventive concept relates to a data storage device, and more particularly, to a data storage device capable of improving reading and writing performance.

Non-volatile memory devices have excellent data storing properties and thus are used as storage media in memory systems. Non-volatile memory devices are regarded as highly-integrated large-capacity devices that are substitutable for conventional hard disks or floppy disks. Currently, non-volatile memory devices are used as storage media in, for example, mobile phones, digital cameras, MPEG-1 audio layer 3 (MP3) players, and solid state drives (SSDs).

### SUMMARY

According to an aspect of the inventive concept, there is provided a data storage device including at least one memory chip comprising a control unit and a plurality of blocks for storing data, and communicating with a host through a channel; and memory storing data output from the at least one memory chip. The control unit may sequentially read data having continuous logic addresses and discontinuous physical addresses from the plurality of blocks and store the data in the memory to have continuous physical addresses.

The control unit may store the data stored in the memory in a corresponding block of a corresponding memory chip during an idle time when the channel is not used.

The control unit may include a selection unit selecting blocks in which the data having continuous logic addresses and discontinuous physical addresses are stored; a transmission unit sequentially reading data having continuous logic addresses from the selected blocks and outputting the data having continuous logic addresses to the memory; a mapping information management unit managing mapping information between logic addresses and physical addresses of the data stored in the memory; and a block control unit erasing the data having continuous logic addresses from the plurality of blocks if all of the data having continuous logic addresses are stored in the memory.

The data storage device may further include non-volatile memory for storing data, and, if all of the data having continuous logic addresses are stored in the memory, the control unit may transmit the data stored in the memory to the non-volatile memory. The at least one memory chip may include the non-volatile memory.

According to another aspect of the inventive concept, there is provided a data storage device including at least one memory chip comprising a control unit and a plurality of blocks for storing data, and communicating with a host through a channel; and a first memory transmitting signals and the data between the host and the at least one memory chip through the channel; and a second memory storing data output from the first memory. The control unit may sequentially read data having continuous logic addresses and discontinuous physical addresses from the plurality of blocks and transmit the data to the first memory to have continuous physical addresses so as to be stored in the second memory.

The control unit may store the data stored in the second memory in a corresponding block of a corresponding memory chip to have continuous physical addresses during an idle time when the channel is not used.

The second memory may be non-volatile memory, and, whenever a portion of the data having continuous logic addresses is transmitted to and stored in the first memory, the control unit may transmit the stored portion of the data from the first memory to the second memory. TThe control unit may include: a selection unit selecting blocks in which the data having continuous logic addresses and discontinuous physical addresses are stored; a transmission unit sequentially reading the data having continuous logic addresses from the selected blocks and outputting the data having continuous logic addresses to the first memory; a mapping information management unit managing mapping information between logic addresses and physical addresses of the data stored in the first memory or the second memory; and a block control unit erasing the data having continuous logic addresses from the plurality of blocks if all of the data having continuous logic addresses are stored in the first memory or the second memory.

The at least one memory chip may include the second memory.

### BRIEF DESCRIPTION OF THE DRAWINGS

Exemplary embodiments of the inventive concept will be more clearly understood from the following detailed description taken in conjunction with the accompanying drawings.

FIG. 1 is a block diagram of a data storage device according to an embodiment of the inventive concept.

FIG. 2 is a block diagram illustrating operation of the data storage device illustrated in FIG. 1, according to an embodiment of the inventive concept.

FIG. 3 is a block diagram illustrating operation of the data storage device illustrated in FIG. 1, according to another embodiment of the inventive concept.

FIGS. 4A through 4D are diagrams illustrating a merge operation of data stored in a data storage medium, a first memory, and a second memory illustrated in FIG. 2 or 3, according to an embodiment of the inventive concept.

FIGS. 5A through 5D are diagrams illustrating a merge operation of data stored in a data storage medium, a first memory, and a second memory illustrated in FIG. 2 or 3, according to another embodiment of the inventive concept.

FIG. 6 is a block diagram of a first memory chip illustrated in FIG. 2 or 3.

### DETAILED DESCRIPTION OF THE EMBODIMENTS

The attached drawings for illustrating exemplary embodiments of the inventive concept are referred to in order to gain a sufficient understanding of the inventive concept, the merits thereof, and the objectives accomplished by the implementation of the inventive concept.

Hereinafter, the inventive concept will be described in detail by description of embodiments of the inventive concept with reference to the attached drawings. Like reference numerals denote like elements in the drawings.

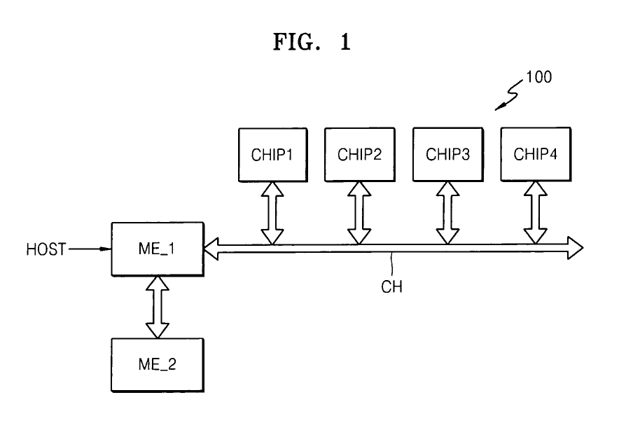

FIG. 1 is a block diagram of a data storage device 100 according to an embodiment of the inventive concept.

Referring to FIG. 1, the data storage device 100 may include a first memory ME_1 and a plurality of memory chips, e.g., first through fourth memory chips CHIP1, CHIP2, CHIP3, and CHIP4. Although the data storage device 100 includes four memory chips in FIG. 1, the number of memory chips is not limited to four and the data storage device 100 may instead include a different number of memory chips while achieving the same effect. The first memory ME_1 may transmit signals and data between a host and the first through fourth memory chips CHIP1, CHIP2, CHIP3, and CHIP4 through a channel CH. The first memory ME_1 may be volatile memory such as dynamic random access memory (DRAM). However, the first memory ME_1 is not limited to DRAM or even volatile memory.

The data storage device 100 may further include a second memory ME_2. The second memory ME_2 may store data stored in the first memory ME_1. The second memory ME_2 may be non-volatile memory such as phase-change random access memory (PRAM). However, the second memory ME_2 is not limited to PRAM or even non-volatile memory. Operation of the data storage device 100 will now be described in detail.

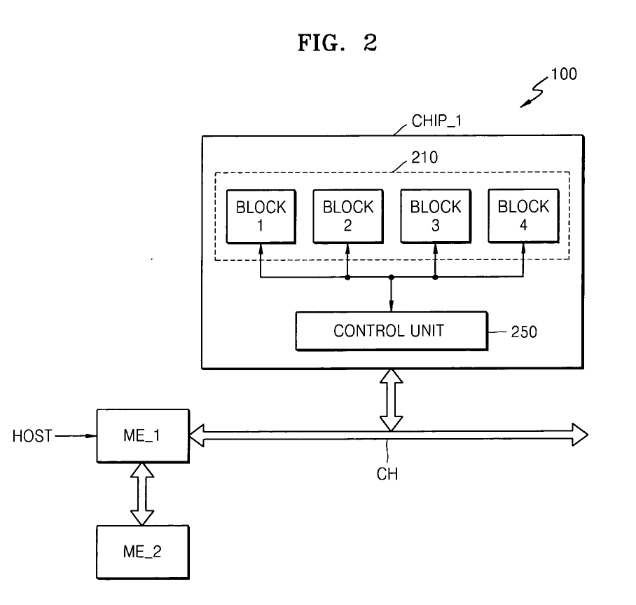

FIG. 2 is a block diagram illustrating operation of the data storage device illustrated in FIG. 1, according to an embodiment of the inventive concept.

In FIG. 2, for simplicity of description, the first memory chip CHIP_1 illustrated in FIG. 1 will be representatively described. The second through fourth memory chips CHIP2, CHIP3, and CHIP4 may have the same structure as that of the first memory chip CHIP_1.

Referring to FIG. 2, the first memory chip CHIP1 may include a control unit 250 and a data storage medium 210 including a plurality of blocks for storing data, e.g., first through fourth blocks BLOCK1, BLOCK2, BLOCK3, and BLOCK4. The data storage medium 210 may be a flash memory device that includes a plurality of blocks, e.g., 1024 blocks or 2048 blocks. A single block may include a plurality of pages, e.g., 16 pages, 32 pages, or 64 pages. Although the data storage medium 210 includes four blocks in FIG. 2 for convenience of description, the number of blocks is not limited to four, and the data storage medium 210 may instead include a different number of blocks while achieving the same effect.

The control unit 250 may perform a merge operation for rearranging data having continuous logic addresses and discontinuous physical addresses that are stored in the first through fourth blocks BLOCK1, BLOCK2, BLOCK3, and BLOCK4 to have continuous physical addresses.

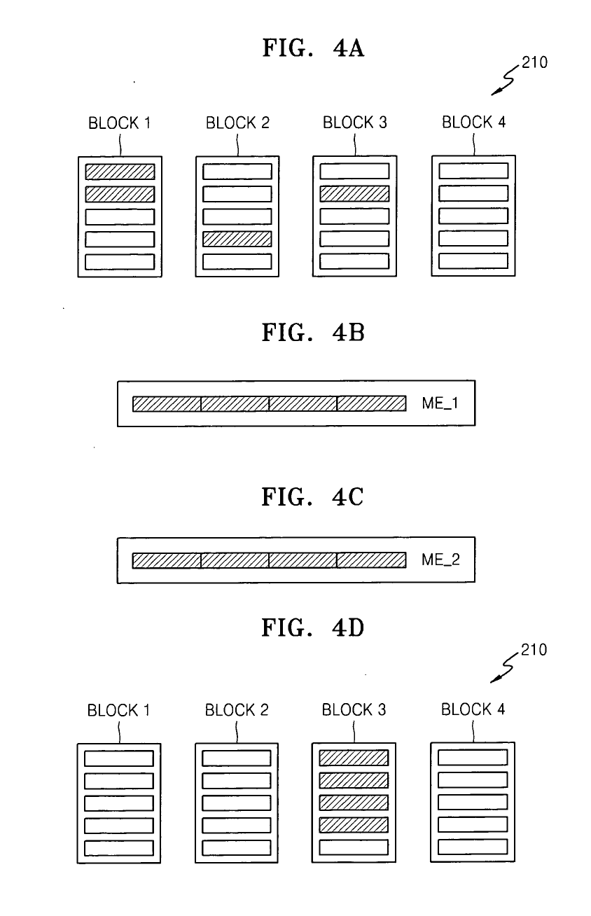

When the merge operation is performed according to an embodiment of the inventive concept, the control unit 250 sequentially reads the data having continuous logic addresses and discontinuous physical addresses from the first through fourth blocks BLOCK1, BLOCK2, BLOCK3, and BLOCK4 and transmits the data having continuous logic addresses and discontinuous physical addresses to the first memory ME_1. The data having continuous logic addresses and discontinuous physical addresses are sequentially stored in the first memory ME_1 to have continuous physical addresses. If all of the data having continuous logic addresses and discontinuous physical addresses are stored in the first memory ME_1 to have continuous physical addresses, the control unit 250 may transmit the data stored in the first memory ME_1 to the second memory ME_2 so as to store the data in the second memory ME_2. However, the transmitting of the data stored in the first memory ME_1 to the second memory ME_2 is optional. For example, if the first memory ME_1 is volatile memory and the second memory ME_2 is non-volatile memory, in order to prevent the data from being erased even when power is cut off, the control unit 250 may transmit the data stored in the first memory ME_1 to the second memory ME_2 so as to store the data in the second memory ME_2. The data stored in the first memory ME_1 or the second memory ME_2 may be called and used by a host, or may be stored in a corresponding block of a corresponding memory chip during an idle time when the channel CH is not used. Thus, the data having continuous logic addresses and discontinuous physical addresses, which are stored in the first through fourth blocks BLOCK1, BLOCK2, BLOCK3, and BLOCK4, may be stored in a corresponding block to have continuous physical addresses. The merge operation according to the current embodiment will be described in detail later in relation to FIGS. 4A through 4D.

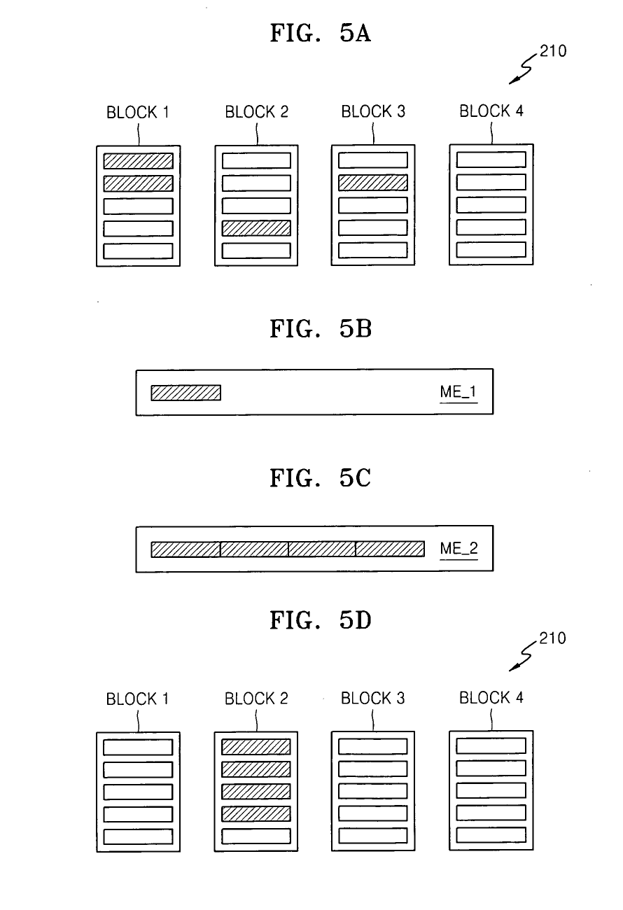

When the merge operation is performed according to another embodiment of the inventive concept, the control unit 250 sequentially reads data having continuous logic addresses and discontinuous physical addresses from the first through fourth blocks BLOCK1, BLOCK2, BLOCK3, and BLOCK4 and separately transmits the data having continuous logic addresses and discontinuous physical addresses to the first memory ME_1 in units. If a portion of the data having continuous logic addresses and discontinuous physical addresses is stored in the first memory ME_1, the control unit 250 may transmit the stored portion of the data to the second memory ME_2. That is, the first memory ME_1 may be used only to transmit the data having continuous logic addresses and discontinuous physical addresses from the first memory chip CHIP1 to the second memory ME_2. For example, if the first through fourth blocks BLOCK1, BLOCK2, BLOCK3, and BLOCK4 include a plurality of pages, the control unit 250 may store the data having continuous logic addresses and discontinuous physical addresses in the first memory ME_1 and then may transmit the data to the second memory ME_2, in page units. If the above operation is performed on all of the data having continuous logic addresses and discontinuous physical addresses, the data having continuous logic addresses and discontinuous physical addresses are stored in the second memory ME_2 to have continuous physical addresses. The data stored in the second memory ME_2 may be called and used by a host, or may be stored in a corresponding block of a corresponding memory chip during an idle time when the channel CH is not used. Thus, the data having continuous logic addresses and discontinuous physical addresses, which are stored in the first through fourth blocks BLOCK1, BLOCK2, BLOCK3, and BLOCK4, may be stored in a corresponding block to have continuous physical addresses. The merge operation according to the current embodiment will be described in more detail below in relation to FIGS. 5A through 5D.

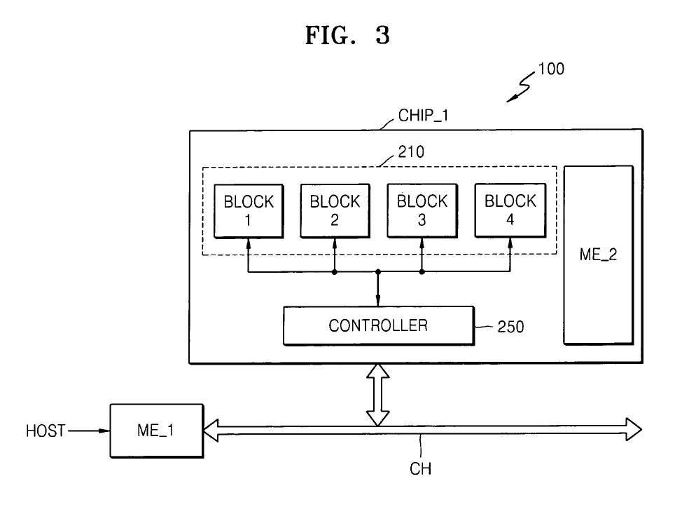

FIG. 3 is a block diagram illustrating operation of the data storage device illustrated in FIG. 1, according to another embodiment of the inventive concept.

In FIG. 3, as in FIG. 2, for simplicity of description, the first memory chip CHIP_1 illustrated in FIG. 1 will be representatively described. The second through fourth memory chips CHIP2, CHIP3, and CHIP4 may have the same structure and operation as that of the first memory chip CHIP_1.

Referring to FIG. 3, the first memory chip CHIP1 may include the control unit 250, the second memory ME_2, and the data storage medium 210 including a plurality of blocks for storing data, e.g., the first through fourth blocks BLOCK1, BLOCK2, BLOCK3, and BLOCK4. That is, the second memory ME_2 illustrated in FIGS. 1 and 2 may be included in each memory chip. Except that the second memory ME_2 is included in each memory chip, the data storage device 100 is structures and operates as described above in relation to FIG. 2 and thus detailed description thereof will not be repeated here. The control unit 250 may also perform a merge operation as described above in relation to FIG. 2.

FIGS. 4A through 4D are diagrams illustrating a merge operation of data stored in the data storage medium 210, the first memory ME_1, and the second memory ME_2 illustrated in FIG. 2 or 3, according to an embodiment of the inventive concept.

The merge operation according to the current embodiment will now be described with reference to FIG. 2 or 3, and FIGS. 4A through 4D. Referring to FIG. 4A, data having continuous logic addresses and discontinuous physical addresses are stored in the data storage medium 210 and are indicated by slashed portions in the first through third blocks BLOCK1, BLOCK2, and BLOCK3. FIG. 4A exemplarily illustrates a case when each of the first through fourth blocks BLOCK1, BLOCK2, BLOCK3, and BLOCK4 has five pages. However, the number of pages is not limited to five and each of the first through fourth blocks BLOCK1, BLOCK2, BLOCK3, and BLOCK4 may instead include a different number of pages while achieving the same effect.

The control unit 250 sequentially reads the data having continuous logic addresses and discontinuous physical addresses from the first through third blocks BLOCK1, BLOCK2, and BLOCK3 and transmits the data having continuous logic addresses and discontinuous physical addresses to the first memory ME_1. Thus, as illustrated in FIG. 4B, the data having continuous logic addresses and discontinuous physical addresses are sequentially stored in the first memory ME_1 to have continuous physical addresses. Then, the control unit 250 may optionally transmit the data stored in the first memory ME_1 to the second memory ME_2 so as to store the data in the second memory ME_2. FIG. 4C illustrates a case when the data stored in the first memory ME_1 are stored in the second memory ME_2. The data stored in the first memory ME_1 or the second memory ME_2 may be stored in a corresponding block of a corresponding memory chip during an idle time when the channel CH is not used. FIG. 4D illustrates a case when the data stored in the first memory ME_1 or the second memory ME_2 are stored in the third block BLOCK3 to have continuous physical address.

FIGS. 5A through 5D are diagrams for describing a merge operation of data stored in the data storage medium 210, the first memory ME_1, and the second memory ME_2 illustrated in FIG. 2 or 3, according to another embodiment of the inventive concept.

The merge operation according to the current embodiment will now be described with reference to FIG. 2 or 3, and FIGS. 5A through 5D. Referring to FIG. 5A, data having continuous logic addresses and discontinuous physical addresses are stored in the data storage medium 210 as illustrated in FIG. 4A.

The control unit 250 sequentially reads the data having continuous logic addresses and discontinuous physical addresses from the first through third blocks BLOCK1, BLOCK2, and BLOCK3 and separately transmits the data having continuous logic addresses and discontinuous physical addresses to the first memory ME_1 in units. It is assumed that the control unit 250 stores data in the first memory ME_1 and transmits the data stored in the first memory ME_1 to the second memory ME_2, in page units. That is, referring to FIG. 5B, the control unit 250 stores data of a first page of the first block BLOCK1 in the first memory ME_1 and transmits the data of the first page to the second memory ME_2 so as to store the data of the first page in the second memory ME_2. After that, the control unit 250 stores data of a second page of the first block BLOCK1 in the first memory ME_1 and then transmits the data of the second page to the second memory ME_2 so as to store the data of the second page in the second memory ME_2. Likewise, the control unit 250 stores data of a fourth page of the second block BLOCK2 and data of a second page of the third block BLOCK3 in the first memory ME_1 and then transmits the data of the fourth page and the second page to the second memory ME_2 so as to store the data of the fourth page and the second page in the second memory ME_2. If all pages including the second page of the third block BLOCK3 are transmitted to the second memory ME_2, as illustrated in FIG. 5C, data of four pages are stored in the second memory ME_2 to have continuous physical addresses. The data stored in the second memory ME_2 may be stored in a corresponding block of a corresponding memory chip during an idle time when the channel CH is not used. FIG. 5D illustrates a case when the data stored in the second memory ME_2 are stored in the second block BLOCK2 to have continuous physical addresses.

In FIGS. 4A through 4D, the data having continuous logic addresses and discontinuous physical addresses are sequentially stored in the first memory ME_1 and then are sequentially transmitted to the second memory ME_2. However, in FIGS. 5A through 5D, the data having continuous logic addresses and discontinuous physical addresses are separately stored in the first memory ME_1 and then are separately transmitted to the second memory ME_2, in units.

The control unit 250 may determine whether to perform the merge operation as described above in relation to FIGS. 4A through 4D or FIGS. 5A through 5D, based on a current state of the channel CH. For example, when the merge operation is to be performed, if the channel CH is continuously used upon a request of the host, the request of the host may be executed by performing the merge operation as described above in relation to FIGS. 4A through 4D or FIGS. 5A through 5D. When the merge operation is to be performed, if the channel CH is idle, the merge operation may be performed as described above in relation to FIGS. 4A through 4D or FIGS. 5A through 5D, or may be performed by using free blocks in which data are not stored. For example, if data are stored in the first through third blocks BLOCK1, BLOCK2, and BLOCK3 and are not stored in the fourth block BLOCK4 as illustrated in FIG. 4A, the data may be transmitted to and stored in the fourth block BLOCK_4 to have continuous physical addresses instead of transmitting the data stored in the first memory ME_1 as illustrated in FIG. 4B or FIG. 5B to the second memory ME_2.

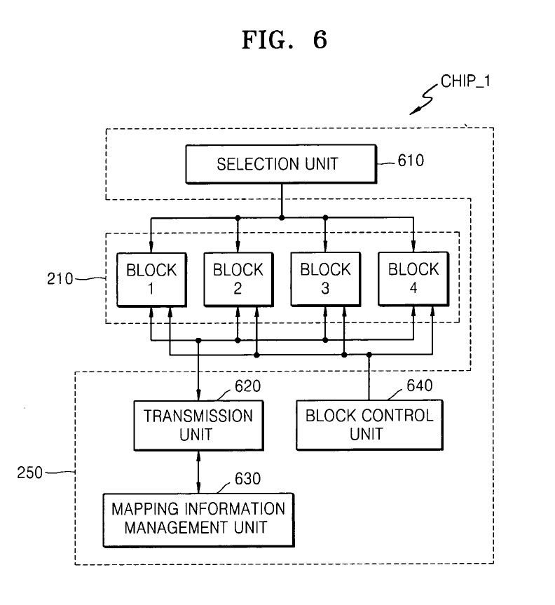

FIG. 6 is a block diagram of the first memory chip CHIP1 illustrated in FIG. 2 or 3.

In FIG. 6, for simplicity of description, the structure of the first memory chip CHIP1 will be representatively described in detail. The second through fourth memory chips CHIP2, CHIP3, and CHIP4 illustrated in FIG. 2 or 3 may also have the structure illustrated in FIG. 6.

Referring to FIG. 6, the first memory chip CHIP1 may include the data storage medium 210 and the control unit 250. The structure of the data storage medium 210 is described above in relation to FIGS. 2 and 3 and thus a detailed description thereof will not be repeated here.

The control unit 250 may include a selection unit 610, a transmission unit 620, a mapping information management unit 630, and a block control unit 640. The selection unit 610 selects blocks in which data having continuous logic addresses and discontinuous physical addresses are stored. The transmission unit 620 sequentially reads data having continuous logic addresses from the selected blocks and outputs the data having continuous logic addresses to a first memory ME_1. The mapping information management unit 630 manages mapping information between logic addresses and physical addresses of the data stored in the first memory ME_1 or the second memory ME_2. If all of the data having continuous logic addresses are stored in the first memory ME_1 or the second memory ME_2, the block control unit 640 erases the data having continuous logic addresses from the selected blocks.

For example, in FIG. 4A, the selection unit 610 selects the first through third blocks BLOCK1, BLOCK2, and BLOCK3, and the transmission unit 620 outputs data having continuous logic addresses (slashed portions) in the first through third blocks BLOCK1, BLOCK2, and BLOCK3 to the first memory ME_1. If all of the data having continuous logic addresses are stored in the first memory ME_1 or the second memory ME_2, the block control unit 640 erases the data having continuous logic addresses from the selected blocks, i.e., the first through third blocks BLOCK1, BLOCK2, and BLOCK3.

While the inventive concept has been particularly shown and described with reference to exemplary embodiments thereof, it will be understood that various changes in form and details may be made therein without departing from the spirit and scope of the following claims.

What is claimed is:

1. A data storage device comprising:
at least one memory chip comprising a control unit and a plurality of blocks for storing data, and communicating with a host through a channel; and
memory storing data output from the at least one memory chip,
wherein the control unit sequentially reads data having continuous logic addresses and discontinuous physical addresses from the plurality of blocks and stores the data in the memory to have continuous physical addresses.

2. The data storage device of claim 1, wherein the control unit stores the data stored in the memory in a corresponding block of a corresponding memory chip during an idle time when the channel is not used.

3. The data storage device of claim 1, wherein the control unit comprises:
a selection unit selecting blocks in which the data having continuous logic addresses and discontinuous physical addresses are stored;
a transmission unit sequentially reading data having continuous logic addresses from the selected blocks and outputting the data having continuous logic addresses to the memory;
a mapping information management unit managing mapping information between logic addresses and physical addresses of the data stored in the memory; and
a block control unit erasing the data having continuous logic addresses from the plurality of blocks if all of the data having continuous logic addresses are stored in the memory.

4. The data storage device of claim 1, further comprising non-volatile memory for storing data,
wherein, if all of the data having continuous logic addresses are stored in the memory, the control unit transmits the data stored in the memory to the non-volatile memory.

5. The data storage device of claim 4, wherein the at least one memory chip comprises the non-volatile memory.

6. A data storage device comprising:
at least one memory chip comprising a control unit and a plurality of blocks for storing data, and communicating with a host through a channel; and
a first memory transmitting signals and the data between the host and the at least one memory chip through the channel; and
a second memory storing data output from the first memory,
wherein the control unit sequentially reads data having continuous logic addresses and discontinuous physical addresses from the plurality of blocks and transmits the data to the first memory to have continuous physical addresses so as to be stored in the second memory.

7. The data storage device of claim 6, wherein the control unit stores the data stored in the second memory in a corresponding block of a corresponding memory chip to have continuous physical addresses during an idle time when the channel is not used.

8. The data storage device of claim 6, wherein the second memory is non-volatile memory, and
wherein, whenever a portion of the data having continuous logic addresses is transmitted to and stored in the first memory, the control unit transmits the stored portion of the data from the first memory to the second memory.

9. The data storage device of claim 6, wherein the control unit comprises:
a selection unit selecting blocks in which the data having continuous logic addresses and discontinuous physical addresses are stored;
a transmission unit sequentially reading the data having continuous logic addresses from the selected blocks and outputting the data having continuous logic addresses to the first memory;
a mapping information management unit managing mapping information between logic addresses and physical addresses of the data stored in the first memory or the second memory; and
a block control unit erasing the data having continuous logic addresses from the plurality of blocks if all of the data having continuous logic addresses are stored in the first memory or the second memory.

10. The data storage device of claim 6, wherein the at least one memory chip comprises the second memory.
